(19) United States
(12) Patent Application Publication
(10) Pub. No.: US 2026/0192525 A1
(43) Pub. Date: Jul. 9, 2026

(54) SELECTIVE PROTECTIVE COATING TO SAFEGUARD WORKPIECE DURING MANUFACTURING PROCESS

(71) Applicant: International Business Machines Corporation, Armonk, NY (US)

(72) Inventor: Sarbajit Kumar Rakshit, Kolkata (IN)

(21) Appl. No.: 19/010,294

(22) Filed: Jan. 6, 2025

(51) Int. Cl. B29C 64/393; B33Y 50/02; G06F 30/20; G06F 113/10; G06F 119/18

(52) U.S. Cl. CPC B29C 64/393; B33Y 50/02; G06F 30/20; G06F 2113/10; G06F 2119/18

(57) ABSTRACT

Examples described herein provide for applying selective protective coatings to safeguard a workpiece during manufacturing. Aspects include analyzing a manufacturing process for the workpiece to identify one or more manufacturing steps that are likely to cause damage to one or more areas of the workpiece and determining one or more materials for coating the one or more areas based on the one or more manufacturing steps. Aspects also include creating a modified manufacturing process of the workpiece by adding one or more additive manufacturing steps to the manufacturing process prior to the one or more manufacturing steps that are likely to cause damage to one or more areas of the workpiece and manufacturing the workpiece based on the modified manufacturing process.

### BACKGROUND

The discourse relates generally to manufacturing technologies and more specifically to applying selective protective coatings to safeguard workpieces during manufacturing processes.

Manufacturing processes often involve various steps that can inadvertently affect unintended areas of a workpiece. Traditional methods lack the ability to selectively protect these areas, leading to potential damage during processes such as heat treatment or chemical processing. This challenge necessitates a method to dynamically safeguard specific portions of a workpiece while allowing manufacturing steps to be applied only where needed.

Existing surface treatment techniques provide certain protective measures but do not offer the flexibility to selectively apply protection based on the specific requirements of different manufacturing steps. These methods often result in the application of treatments beyond the intended boundaries, causing undesired alterations to the workpiece. The need for a more precise and adaptable protective system is evident to enhance manufacturing efficiency and product integrity.

### SUMMARY

According to one aspect of the present invention, a computer-implemented method for applying selective protective coatings to safeguard a workpiece during manufacturing is provided. The computer-implemented method includes analyzing a manufacturing process for the workpiece to identify one or more manufacturing steps that are likely to cause damage to one or more areas of the workpiece and determining one or more materials for coating the one or more areas based on the one or more manufacturing steps. The computer-implemented method also includes creating a modified manufacturing process of the workpiece by adding one or more additive manufacturing steps to the manufacturing process prior to the one or more manufacturing steps that are likely to cause damage to one or more areas of the workpiece and manufacturing the workpiece based on the modified manufacturing process.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a block diagram of a computing environment, according to one or more embodiments;

FIG. 2 illustrates a block diagram of a system for selectively applying protective coatings to a workpiece during manufacturing, according to one or more embodiments;

FIG. 3A illustrates a workpiece with designated areas for different manufacturing processes;

FIG. 3B illustrates the application of coatings on a workpiece to protect unintended areas while allowing processes on intended areas;

FIG. 3C illustrates a cross-sectional view of a workpiece with various coatings applied to different areas;

FIG. 3D illustrates a flow chart diagram of a method for selectively applying protective coatings to a workpiece during manufacturing; and

FIG. 4 illustrates a flow chart diagram of a method for selectively applying protective coatings to a workpiece during manufacturing, according to one or more embodiments.

The detailed description explains embodiments of the disclosure, together with advantages and features, by way of example with reference to the drawings.

### DETAILED DESCRIPTION

In manufacturing, multiple steps can unintentionally impact areas of a workpiece that should remain unaffected. Traditional approaches often fail to selectively shield these areas, resulting in potential damage during processes like heat treatment, hardening, or chemical processing. This issue highlights the need for a method that can dynamically protect specific parts of a workpiece, ensuring that manufacturing steps are applied only where necessary. While existing surface treatment techniques offer some protection, they lack the flexibility to tailor protection to the unique requirements of different manufacturing steps. Consequently, treatments may extend beyond intended boundaries, leading to unwanted changes in the workpiece. A more precise and adaptable protective system is crucial to improve manufacturing efficiency and maintain product integrity.

In exemplary embodiments, a dynamic protective coating system that effectively safeguards unintended portions of the workpiece from the impact of manufacturing steps is provided. By analyzing manufacturing steps and their influencing factors, the system identifies areas requiring protection and dynamically determines suitable types and thicknesses of a second material for coating. The system simulates the impact of influencing factors, generates a three-dimensional protective layer model, and creates a dynamic manufacturing workflow. Autonomous industrial machines execute the workflow, selectively applying required manufacturing steps to intended portions while leaving unintended portions unaffected.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

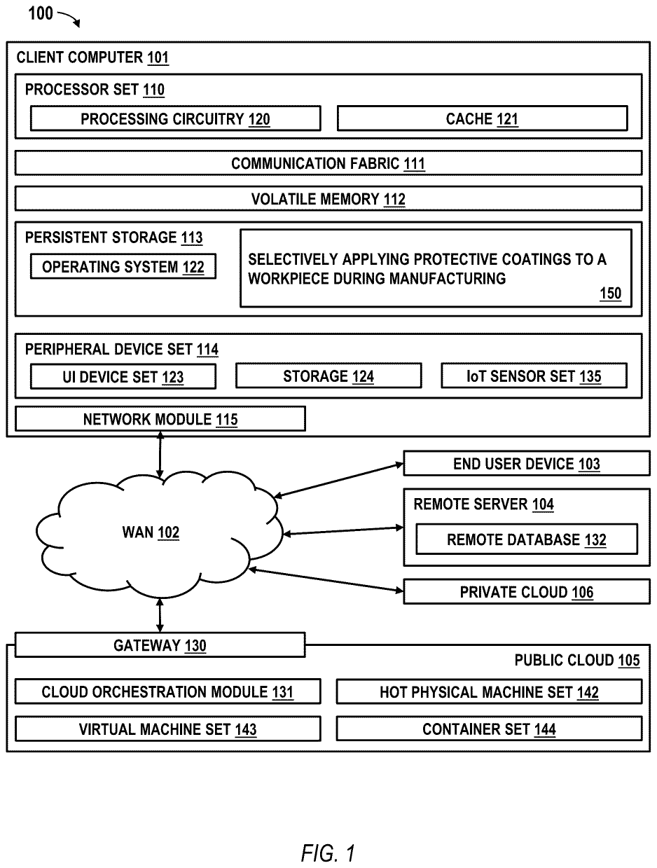

FIG. 1 illustrates a computing environment 100, according to an embodiment. Computing environment 100 contains an example of an environment for the execution of at least some of the computer code involved in selectively applying protective coatings to a workpiece during manufacturing, as shown at block 150. In addition to a controller for controlling the operations of a metal cutting tool, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in persistent storage 113 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the computing environment 100 can provide for remote data storage. For example, the computer 101 can be a cloud storage system or other suitable system for storing data that is accessible to a user remotely, such as by accessing the computer 101 using the end user device 103. That is, a user can send a user operation (also referred to as a “user request”) from the end user device 103 to the computer 101 via the WAN 102. Although the user operation may appear to be simple, such as uploading an object to a cloud storage system, the complications of operating a cloud computing system often have side effects and produce ancillary data, which may be consumed by both the operator of the system (e.g., the computer 101) and by users or other components of the cloud architecture (e.g., the computing environment 100). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the owner of the entity is also updated).

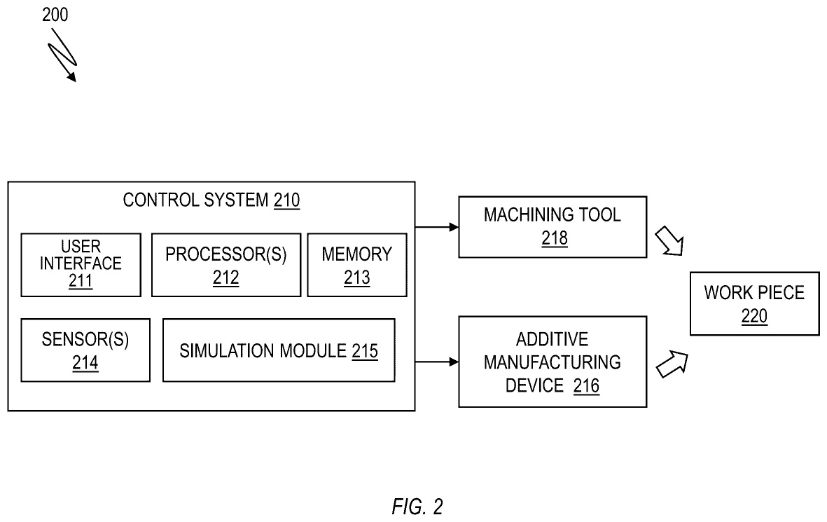

Referring now to FIG. 2, a block diagram of a system 200 selectively applying protective coatings to a workpiece during manufacturing is shown. The system 200 includes a control system 210 having processor(s) 212, user interface 211, a memory 213, sensor(s) 214, and a simulation module 215. The system 200 also includes one or more machining tools 218 and additive manufacturing devices 216, which are operated by the control system 210, to manufacture a work piece 220.

In exemplary embodiments, the control system 210 orchestrates the selective application of protective coatings to a workpiece during manufacturing. This control system 210 integrates various components to ensure precise execution of the manufacturing process. The control system 210 includes a user interface 211 that is configured to allow operators to input parameters and monitor the manufacturing process. The user interface 211 provides a platform for real-time interaction, enabling adjustments and oversight of the manufacturing workflow. The control system 200 also includes processor(s) 212 that execute the computational tasks required for analyzing manufacturing steps and determining protective measures. These processors perform complex calculations, including simulations and data analysis, to identify areas of the workpiece that require protection. The processor(s) 212 interact with the memory 213, which stores the necessary data and instructions for executing the protective coating process. The memory 213 retains information about manufacturing steps, influencing factors, and historical data, facilitating informed decision-making by the processor(s) 212.

In exemplary embodiments, the control system 210 includes sensor(s) 214 that provide real-time data on the manufacturing environment and the workpiece. These sensors detect variables such as temperature, pressure, and chemical exposure, which influence the protective coating process. The sensor(s) 214 feed this data to the processor(s) 212, enabling dynamic adjustments to the protective measures based on current conditions. In exemplary embodiments, the simulation module 215 is configured to perform simulations of the manufacturing process. The simulation module 215 module evaluates the impact of various influencing factors on the workpiece and the effectiveness of different protective coatings. By simulating different scenarios, the simulation module 215 aids in determining the optimal type and thickness of the protective coating to be applied.

In exemplary embodiments, the simulation module 215 is designed to perform simulations of the manufacturing process, evaluating the impact of various influencing factors on the workpiece and the effectiveness of different protective coatings. The simulation module 215 incorporates a machine learning module trained on data collected from the sensors 214. These sensors provide real-time data on variables such as temperature, pressure, and chemical exposure during manufacturing. The machine learning module uses this data to learn patterns and predict outcomes, enabling the simulation module to accurately model different scenarios. By simulating these scenarios, the module determines the optimal type and thickness of protective coatings needed to safeguard the workpiece. This predictive capability allows for dynamic adjustments to the protective measures, ensuring that the coatings are applied effectively and efficiently, tailored to the specific conditions of the manufacturing environment.

In exemplary embodiments, the additive manufacturing device 216 implements the application of protective coatings as determined by the control system 210. The additive manufacturing device 216 device utilizes techniques such as 3D printing to apply precise layers of protective material to the workpiece. The additive manufacturing device 216 operates in conjunction with the machining tool 218, which performs the necessary manufacturing steps on the intended portions of the workpiece. The coordination between the additive manufacturing device 216 and the machining tool 218ensures that the protective coatings are applied accurately and that the manufacturing steps are executed without affecting unintended areas.

The work piece 220 represents the object undergoing the manufacturing process. The control system 210, through the various components of the control system 210, ensures that the work piece 220 receives the necessary protective coatings to safeguard against potential damage during manufacturing. The control system 200 dynamically adjusts the protective measures based on real-time data and simulations, ensuring that the work piece 220 is processed according to the specified requirements.

In an example scenario, a workpiece requires protection against two distinct manufacturing steps: abrasive blasting and chemical treatment. To achieve this, two layers of different coatings with non-uniform thickness are sequentially applied to a specific area of the workpiece. First, a base layer of a durable, impact-resistant material is applied to shield the workpiece from the high kinetic energy of abrasive particles during blasting. This layer is thicker in areas expected to receive the most impact, ensuring optimal protection while minimizing material use. Next, a second layer of a chemically resistant coating is added on top of the first layer. This coating is designed to protect against potential chemical reactions during the subsequent chemical treatment process. The thickness of this layer varies, being thicker in regions more exposed to chemical exposure. By using these two layers with non-uniform thickness, the workpiece is effectively safeguarded against both manufacturing steps, ensuring that only the intended areas are affected while maintaining the integrity of the rest of the workpiece.

In another example scenario, a workpiece requires protection against two different manufacturing steps, flame hardening and chemical treatment, that are performed on different areas of the workpiece. To address this, two layers of different coatings with non-uniform thickness are applied to the different areas of the workpiece. For the area exposed to flame hardening, a heat-resistant coating is applied. This layer is thicker in regions expected to experience higher temperatures, providing optimal thermal protection while minimizing material use. In another area subjected to chemical treatment, a chemically resistant coating is applied. This layer varies in thickness, being thicker in sections more exposed to potential chemical reactions, ensuring effective protection. By applying these two distinct coatings with non-uniform thickness to different areas, the workpiece is effectively safeguarded against both manufacturing steps, maintaining the integrity of the workpiece while allowing the intended processes to occur.

In exemplary embodiments, after the manufacturing steps that required protective coatings are completed, the process involves detecting and removing any remaining applied coatings from the workpiece. This step begins with sensors scanning the workpiece to identify areas where coatings remain. Once detected, a robotic system is employed to carefully remove the coatings without damaging the underlying material. The robot uses precise tools and techniques, such as mechanical peeling or chemical solvents, to ensure complete removal. This step restores the workpiece to its intended specifications, ensuring that no residual coatings interfere with the final product's functionality or appearance.

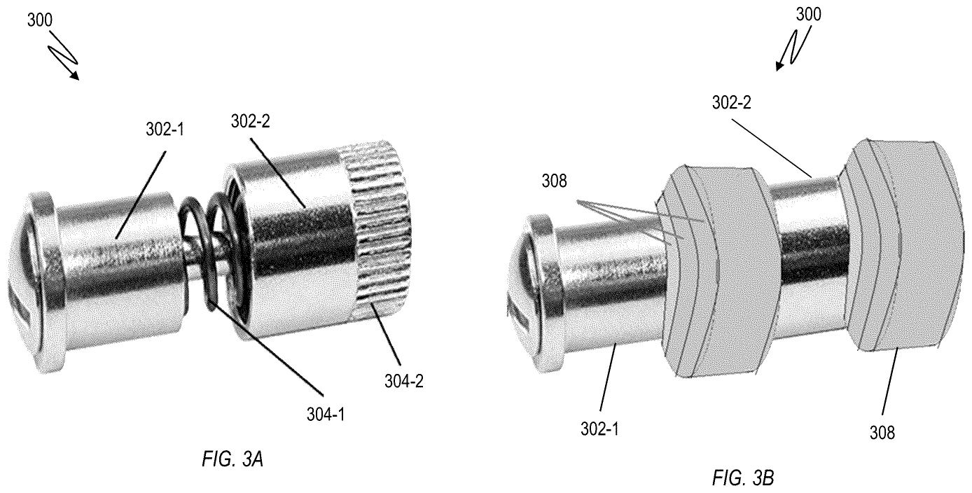

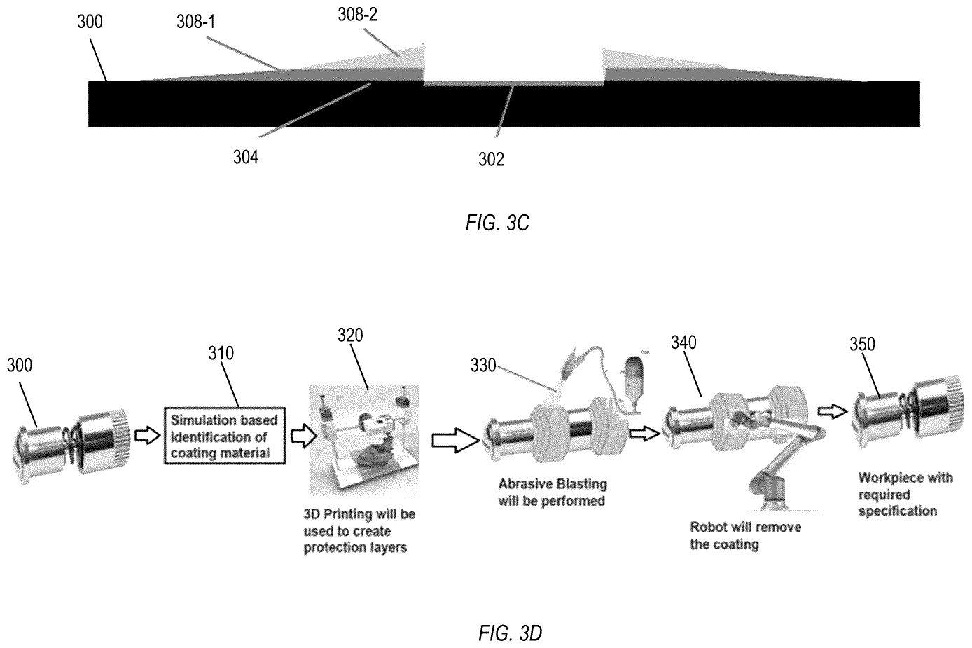

FIG. 3A illustrates a workpiece 300 with various areas designated for different manufacturing processes. The workpiece includes intended work area 302-1 and 302-2, referred to collectively herein as intended work areas 302, and unintended work areas 304-1 and 304-2, referred to collectively herein as unintended work areas 304. The workpiece 300 is an object undergoing manufacturing processes, designed to accommodate specific treatments while protecting certain areas from unintended exposure. The unintended work areas 304 represent sections of the workpiece that require protection from manufacturing processes. These areas are not intended to undergo any modifications and remain unaffected by the applied processes. The intended work areas 302 are the designated section on the workpiece where manufacturing processes are intended to occur. In exemplary embodiments, the intended work areas 302 are prepared to receive specific treatments or modifications as part of the manufacturing workflow.

FIG. 3B illustrates the application of coatings 308 on the workpiece 300. The coatings 308 are strategically applied to protect the unintended work areas 304 while allowing processes to be conducted on the intended work areas 302. The coatings 308 ensure that only the intended areas are exposed to manufacturing steps, preserving the integrity of the workpiece. In exemplary embodiments, one or more layers of coatings 308 may be applied to the unintended work areas 304. The applied coatings 308 may be made of various different materials and may be applied in layers with various thickness, which may be uniform or non-uniform.

FIG. 3C shows a cross-sectional view of a workpiece 300 with various coatings applied to different areas. The workpiece 300 includes an unintended work area 304 and an intended work area 302. The figure also illustrates a first coating layer 308-1 and a second coating layer 308-2 applied to the workpiece 300. In exemplary embodiments, the workpiece 300 is designed to accommodate specific treatments while protecting certain areas from unintended exposure. The unintended work area 304 represents sections of the workpiece 300 that require protection from manufacturing processes. These areas are not intended to undergo any modifications and remain unaffected by the applied processes. The intended work area 302 is the designated section on the workpiece 300 where manufacturing processes are intended to occur. The intended work area 302 is prepared to receive specific treatments or modifications as part of the manufacturing workflow.

In exemplary embodiments, a first coating layer 308-1 is applied to the unintended work area 304 to protect the unintended work area 304 from the manufacturing processes. The first coating layer 308-1 may be made of various materials and applied in layers with varying thickness, which may be uniform or non-uniform. The first coating layer 308-1 ensures that only the intended areas are exposed to manufacturing steps, preserving the integrity of the workpiece 300. A second coating layer 308-2 is applied on top of the first coating layer 308-1 to provide additional protection. The second coating layer 308-2 may vary in thickness, being thicker in regions more exposed to potential manufacturing impacts. The second coating layer 308-2 enhances the protective measures, ensuring that the workpiece 300 is effectively safeguarded against the manufacturing steps.

FIG. 3D shows a method for selectively applying protective coatings to a workpiece during manufacturing. The method can be implemented by a control system 210, as shown in FIG. 2, to ensure precise application and removal of protective layers. At step 310, the method involves simulation-based identification of coating material. This step utilizes simulations to determine the optimal type and thickness of protective coatings required for the workpiece, considering the specific manufacturing processes involved. Next, at step 320, 3D printing is used to create protection layers. The method employs additive manufacturing techniques to apply the identified protective coatings onto the workpiece, ensuring precise coverage of areas that require safeguarding. At step 330, abrasive blasting is performed. In exemplary embodiments, the method applies abrasive blasting to the workpiece, targeting only the intended areas while the protective coatings shield the unintended sections from damage. Next, as shown at step 340, a robot removes the coating. In exemplary embodiments, the method utilizes robotic systems to carefully strip away the protective layers from the workpiece, ensuring that the underlying material remains intact and undamaged. At step 350, the workpiece achieves the required specification. In exemplary embodiments, the method concludes with the workpiece meeting the desired specifications, having undergone the necessary manufacturing processes while maintaining the workpiece's integrity through the selective application and removal of protective coatings.

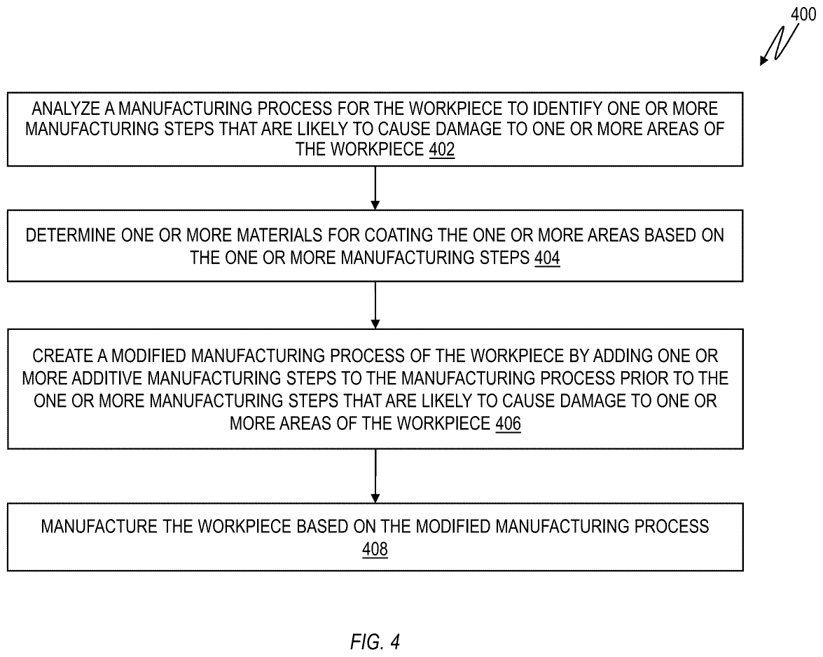

Referring now to FIG. 4, a flow chart illustrating a method 400 for selectively applying protective coatings to a workpiece during manufacturing is shown. The method 400 can be implemented by a control system 210, as shown in FIG. 2. As shown at block 402, the method 400 begins with analyzing a manufacturing process for the workpiece to identify one or more manufacturing steps that are likely to cause damage to one or more areas of the workpiece. In exemplary embodiments, the analysis involves evaluating the specific manufacturing steps involved in the process and determining which steps may pose a risk to certain areas of the workpiece. The analysis may include simulating the manufacturing process for the workpiece, allowing for a detailed understanding of potential impacts and vulnerabilities.

Next, once the analysis is complete, the method 400 proceeds to block 404 and determines one or more materials for coating the one or more areas based on the one or more manufacturing steps. In exemplary embodiments, the determination involves selecting materials that can effectively protect the identified areas of the workpiece during the manufacturing steps that are likely to cause damage. The materials are chosen for their protective properties, ensuring that they can withstand the specific conditions of the manufacturing process. As shown at block 406, the method 400 also includes creating a modified manufacturing process of the workpiece by adding one or more additive manufacturing steps to the manufacturing process prior to the one or more manufacturing steps that are likely to cause damage to one or more areas of the workpiece. In exemplary embodiments, the additive manufacturing steps apply the one or more materials to the one or more areas of the workpiece, forming a protective layer that shields the workpiece from potential damage. The one or more materials for coating the one or more areas are configured to provide protection for one or more areas of the workpiece during the one or more manufacturing steps that are likely to cause damage to one or more areas of the workpiece.

The method 400 also include manufacturing the workpiece based on the modified manufacturing process, as shown at block 408. In exemplary embodiments, manufacturing the workpiece based on the modified manufacturing process ensures that the workpiece undergoes the necessary manufacturing steps while being protected by the applied coatings. The protective layers are applied based on a three-dimensional protective layer model, which represents an application of the one or more materials on the one or more areas of the workpiece. The one or more additive manufacturing steps are configured to apply the one or more materials based on the three-dimensional protective layer model.

In exemplary embodiments, the method 400 may include the application of a first material that is disposed directly on the workpiece. The one or more materials include a first material that is disposed directly on the workpiece. Additionally, the method may involve the application of a second material that is at least partially disposed directly on the first material. The one or more materials include a second material that is at least partially disposed directly on the first material. One or more of the first material and the second material is disposed in a layer that has a non-uniform thickness, ensuring that the protective layers are tailored to the specific needs of the workpiece and the manufacturing process.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method for selectively applying protective coatings to a workpiece during manufacturing, the method comprising:
analyzing a manufacturing process for the workpiece to identify one or more manufacturing steps that are likely to cause damage to one or more areas of the workpiece;
determining one or more materials for coating the one or more areas based on the one or more manufacturing steps;
creating a modified manufacturing process of the workpiece by adding one or more additive manufacturing steps to the manufacturing process prior to the one or more manufacturing steps that are likely to cause damage to one or more areas of the workpiece, wherein the one or more additive manufacturing steps apply the one or more materials to the one or more areas of the workpiece; and
manufacturing the workpiece based on the modified manufacturing process.

2. The computer-implemented method of claim 1, wherein the one or more materials for coating the one or more areas are configured to provide protection for one or more areas of the workpiece during the one or more manufacturing steps that are likely to cause damage to one or more areas of the workpiece.

3. The computer-implemented method of claim 1, wherein analyzing the manufacturing process for the workpiece to identify the one or more manufacturing steps that are likely to cause damage to the one or more areas of the workpiece comprises simulating the manufacturing process for the workpiece.

4. The computer-implemented method of claim 1, further comprising generating a three-dimensional protective layer model representing an application of the one or more materials on the one or more areas of the workpiece.

5. The computer-implemented method of claim 4, wherein the one or more additive manufacturing steps are configured to apply the one or more materials based on the three-dimensional protective layer model.

6. The computer-implemented method of claim 1, wherein the one or more materials include a first material that is disposed directly on the workpiece.

7. The computer-implemented method of claim 6, wherein the one or more materials include a second material that is at least partially disposed directly on the first material.

8. The computer-implemented method of claim 7, wherein one or more of the first material and the second material is disposed in a layer that has a non-uniform thickness.

9. A system comprising:
a memory comprising computer readable instructions; and
a processing device for executing the computer readable instructions, the computer readable instructions controlling the processing device to perform operations comprising:
analyzing a manufacturing process for a workpiece to identify one or more manufacturing steps that are likely to cause damage to one or more areas of the workpiece;
determining one or more materials for coating the one or more areas based on the one or more manufacturing steps;
creating a modified manufacturing process of the workpiece by adding one or more additive manufacturing steps to the manufacturing process prior to the one or more manufacturing steps that are likely to cause damage to one or more areas of the workpiece, wherein the one or more additive manufacturing steps apply the one or more materials to the one or more areas of the workpiece; and
manufacturing the workpiece based on the modified manufacturing process.

10. The system of claim 9, wherein the one or more materials for coating the one or more areas are configured to provide protection for one or more areas of the workpiece during the one or more manufacturing steps that are likely to cause damage to one or more areas of the workpiece.

11. The system of claim 9, wherein analyzing the manufacturing process for the workpiece to identify the one or more manufacturing steps that are likely to cause damage to the one or more areas of the workpiece comprises simulating the manufacturing process for the workpiece.

12. The system of claim 9, wherein the operations further comprise generating a three-dimensional protective layer model representing an application of the one or more materials on the one or more areas of the workpiece.

13. The system of claim 12, wherein the one or more additive manufacturing steps are configured to apply the one or more materials based on the three-dimensional protective layer model.

14. The system of claim 9, wherein the one or more materials include a first material that is disposed directly on the workpiece.

15. The system of claim 14, wherein the one or more materials include a second material that is at least partially disposed directly on the first material.

16. The system of claim 15, wherein one or more of the first material and the second material is disposed in a layer that has a non-uniform thickness.

17. A computer program product for applying selective protective coatings to safeguard a workpiece during manufacturing, the computer program product comprising:
a set of one or more computer-readable storage media;
program instructions, collectively stored in the set of one or more storage media, for causing a processor set to perform the following computer operations:
analyzing a manufacturing process for the workpiece to identify one or more manufacturing steps that are likely to cause damage to one or more areas of the workpiece;
determining one or more materials for coating the one or more areas based on the one or more manufacturing steps;
creating a modified manufacturing process of the workpiece by adding one or more additive manufacturing steps to the manufacturing process prior to the one or more manufacturing steps that are likely to cause damage to one or more areas of the workpiece, wherein the one or more additive manufacturing steps apply the one or more materials to the one or more areas of the workpiece; and
manufacturing the workpiece based on the modified manufacturing process.

18. The computer program product of claim 17, wherein the one or more materials for coating the one or more areas are configured to provide protection for one or more areas of the workpiece during the one or more manufacturing steps that are likely to cause damage to one or more areas of the workpiece.

19. The computer program product of claim 17, wherein analyzing the manufacturing process for the workpiece to identify the one or more manufacturing steps that are likely to cause damage to the one or more areas of the workpiece comprises simulating the manufacturing process for the workpiece.

20. The computer program product of claim 17, wherein the operations further comprise generating a three-dimensional protective layer model representing an application of the one or more materials on the one or more areas of the workpiece.
